(19) United States
(12) Patent Application Publication
(10) Pub. No.: US 2025/0378405 A1
(43) Pub. Date: Dec. 11, 2025

(54) SYSTEM AND METHOD FOR PRODUCT-LED GROWTH ORCHESTRATION AND ANALYTICS IN SELF-SERVICE SAAS APPLICATIONS

(71) Applicant: Gururaj Krishna Pandurangi, Sammamish, CA (US)

(72) Inventor: Gururaj Krishna Pandurangi, Sammamish, CA (US)

(21) Appl. No.: 19/096,649

(22) Filed: Mar. 31, 2025

Related U.S. Application Data
(60) Provisional application No. 63/571,446, filed on Mar. 29, 2024.

(51) Int. Cl. G06Q 10/0633; G06Q 10/10

(52) U.S. Cl. CPC G06Q 10/0633; G06Q 10/103

(57) ABSTRACT

A method for enabling self-service capabilities in Software as a Service (Saas) applications comprises hosting, by a multi-tenant platform, signup and login pages for a SaaS builder's application. The multi-tenant platform receives authentication requests from prospective users of the SaaS builder's application and transmits authentication request payload to the SaaS builder's application for verification. Upon receiving verification acknowledgement from the SaaS builder's application, a self-service orchestration layer of the multi-tenant platform orchestrates user onboarding workflows including application roles, pricing plans, and tenant management. A telemetry API layer of the multi-tenant platform collects usage data from the orchestrated workflows and stores this collected usage data in at least one database. Finally, an analytics layer of the multi-tenant platform generates product-led growth analytics reports based on the stored usage data.

### CLAIM OF PRIORITY

This application claims priority to U.S. Provisional Application No. 63/571,446, filed on Mar. 29, 2024. This provisional patent application is hereby incorporated by reference in its entirety.

### BACKGROUND

The software-as-a-service (SaaS) industry has undergone significant transformation in recent years, with end-users increasingly expecting self-servable products that can be explored, evaluated, and purchased without extensive interaction with sales teams. Traditional go-to-market strategies that rely heavily on sales-led approaches are being supplemented or replaced by product-led growth (PLG) methodologies, where the product itself serves as the primary customer acquisition and expansion channel. Despite this market shift, SaaS builders face considerable technical challenges in implementing effective self-service capabilities, including managing user authentication, orchestrating signup workflows, analyzing user journeys, and optimizing monetization strategies. Current solutions typically require substantial engineering resources and often result in fragmented systems where self-service components, analytics, and monetization tools operate as separate, disconnected platforms. This fragmentation leads to integration complexities, data synchronization issues, and inefficient optimization of the end-to-end user experience. Furthermore, existing tools often lack the comprehensive telemetry and analytics capabilities necessary to properly measure and optimize product-led growth initiatives. The present invention addresses these limitations by providing an integrated platform that enables SaaS builders to rapidly implement self-service capabilities, gain actionable insights into user journeys, and deploy effective monetization strategies through a unified, scalable architecture.

### SUMMARY OF THE INVENTION

In one aspect, a method for enabling self-service capabilities in Software as a Service (Saas) applications comprises hosting, by a multi-tenant platform, signup and login pages for a SaaS builder's application. The multi-tenant platform receives authentication requests from prospective users of the SaaS builder's application and transmits authentication request payload to the SaaS builder's application for verification. Upon receiving verification acknowledgement from the SaaS builder's application, a self-service orchestration layer of the multi-tenant platform orchestrates user onboarding workflows including application roles, pricing plans, and tenant management. A telemetry API layer of the multi-tenant platform collects usage data from the orchestrated workflows and stores this collected usage data in at least one database. Finally, an analytics layer of the multi-tenant platform generates product-led growth analytics reports based on the stored usage data.

### BRIEF DESCRIPTION OF THE DRAWINGS

FIG. 1 illustrates an example platform for expediting SaaS builders in building/developing, analyzing, and executing product-led growth strategies, according to some embodiments.

FIG. 2 illustrates an example process, according to some embodiments.

FIG. 3 illustrates an example system architecture for a platform for expediting SaaS builders, according to some embodiments.

FIG. 4 illustrates an example SaaS builder system, according to some embodiments.

FIG. 5 illustrates an example platform interaction with a customer's SaaS product, according to some embodiments.

FIG. 6 illustrates an example process for implementing a Self-Service orchestration layer, according to some embodiments.

FIG. 7 illustrates an example process for implementing a Telemetry API Layer, according to some embodiments.

FIG. 8 illustrates an example process for enabling self-service capabilities in Software as a Service (SaaS) applications, according to some embodiments.

The Figures described above are a representative set and are not an exhaustive with respect to embodying the invention.

### DESCRIPTION

Disclosed are a system, method, and article of manufacture for implementing a platform for product-led growth orchestration and analytics in self-service SaaS applications. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

ClickHouse is an open-source, column-oriented database management system specifically designed for online analytical processing that enables real-time analysis of large datasets. It achieves exceptional performance by storing data in columns rather than rows, allowing it to process only the necessary columns for each query instead of entire data rows. ClickHouse is highly scalable across both single servers and distributed clusters, capable of processing billions of rows per second while maintaining sub-second query response times even with petabyte-scale data volumes. It is noted that in other embodiments, other database management system(s) can be utilized.

Cloud computing can be the on-demand availability of computer system resources, especially data storage (e.g. cloud storage) and computing power, without direct active management by the user.

Cloud storage is a model of computer data storage in which data, said to be on “the cloud”, is stored remotely in logical pools and is accessible to users over a network, typically the Internet. The physical storage spans multiple servers (e.g. in multiple locations), and the physical environment is typically owned and managed by a cloud computing provider. These cloud storage providers are responsible for keeping the data available and accessible, and the physical environment secured, protected, and running.

Multi-tenant platform is a software architecture where a single instance of the application serves multiple customer organizations (e.g. tenants) while keeping their data isolated and secure from each other. Each tenant shares the application code, infrastructure, and computational resources, but maintains completely separate data environments, configurations, and user experiences. This approach enables cost-efficient scaling, streamlined maintenance, and feature deployment across all customers simultaneously, while still providing customization options for individual tenant requirements.

Software as a service (SaaS) is a software licensing and delivery model in which software is licensed on a subscription basis and is centrally hosted. SaaS solutions can provide, inter alia: on-demand software, web-based software, or web-hosted software. SaaS solutions utilize cloud computing, along with infrastructure as a service (IaaS) and platform as a service (PaaS). SaaS applications can typically accessed by users of a web browser (e.g. a thin client). SaaS solutions can be used as a delivery model for various business applications as well.

### Example Systems and Methods

Examples of a Self-Service SaaS Enablement Platform are now discussed. The Self-Service SaaS Enablement Platform is designed to help SaaS builders implement Product-Led Growth (PLG) strategies. In some embodiments, the Self-Service SaaS Enablement Platform can have three core capabilities:
Building self-serve products with no-code methodology;
Analyzing user journeys with PLG analytics; and
Driving monetization and retention for Go-to-Market teams.

Self-Service SaaS Enablement Platform can be implement with the following example system architecture. A Self-Service Orchestration Layer manages signup/login pages and authentication. A Telemetry API Layer bridges the orchestration layer with analytics. An Analytics Layer that processes data and generates reports. Self-Service SaaS Enablement Platform can be multi-tenant, cloud-based, and uses various data stores (e.g. S3 Bucket, Postgres DB, and Mongo DB, etc.).

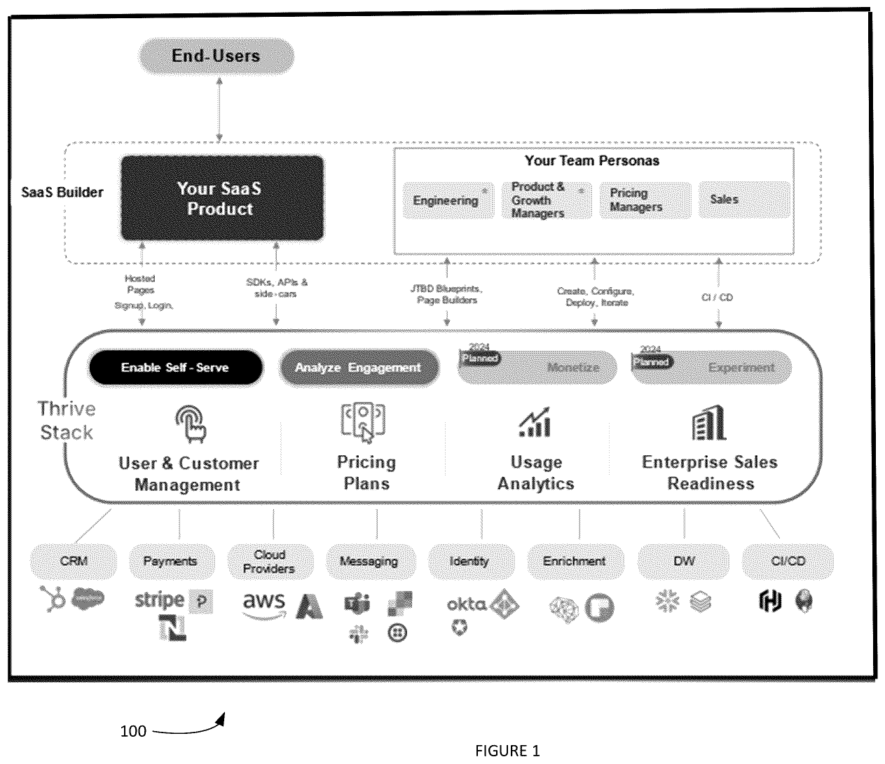

FIG. 1 illustrates an example platform 100 for expediting SaaS builders in building/developing, analyzing, and executing product-led growth strategies, according to some embodiments. Platform 100 provides a purposefully crafted platform expressly designed to expedite SaaS builders in building/developing, analyzing, and executing Product-Led Growth strategies. Platform 100 can implement process 200.

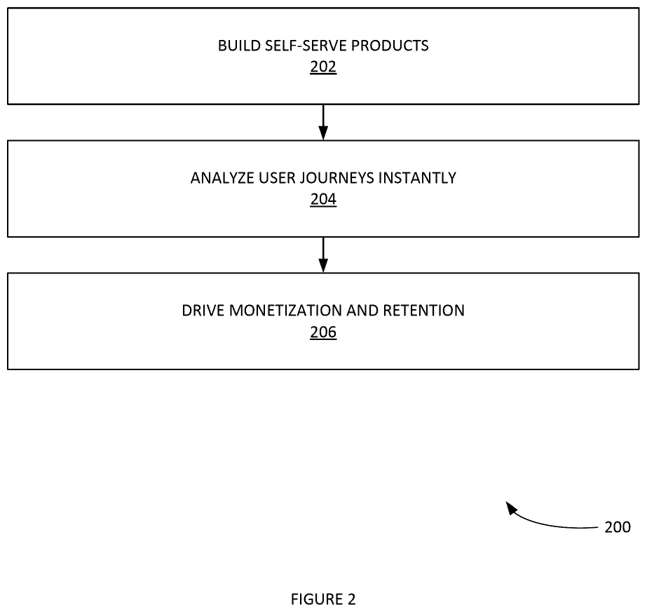

FIG. 2 illustrates an example process 200, according to some embodiments. In step 202, process 200 can build self-serve products. Empower engineering teams with a streamlined no-code methodology to seamlessly orchestrate end-to-end self-service features. This encompasses the transformation of conventional “Contact Us” forms into aesthetically pleasing “Signup” and “Login” experiences, without the encumbrance of managing the intricate infrastructure for user identification, authentication, registration, data-enrichment and welcome email notifications.

In step 204, process 200 can analyze user journeys instantly (e.g. assuming various latencies such as processor latency, networking latency, etc.). Process 200 can furnish growth teams with sophisticated tools to delineate and quantify product-led growth metrics, optimize customer journeys, and facilitate cross-functional collaboration. The inclusion of PLG analytics provides builders with invaluable insights into the usage journeys of self-serve users, enabling a comprehensive understanding and enhancement of the user experience.

In step 206, process 200 can drive monetization and retention. Process 200 grant Go-to-Market (GTM) teams the capability to implement and experiment with effective self-service monetization and retention strategies, thereby placing them at the helm for maximizing success.

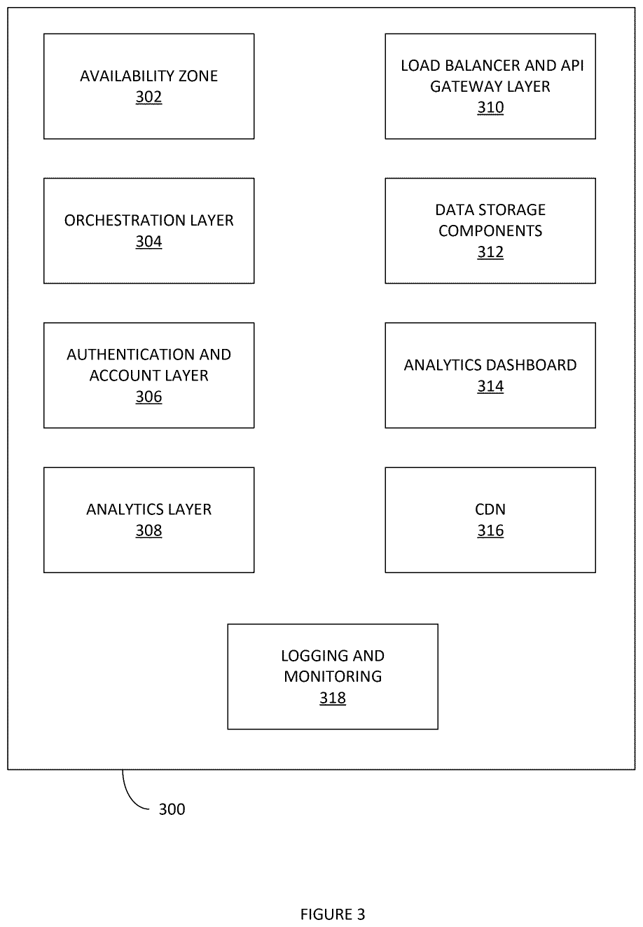

FIG. 3 illustrates an example system architecture 300 for a platform for expediting SaaS builders, according to some embodiments. System architecture 300 can be used to implement SaaS Builders 404 A-B and/or SaaS builder platform 402 discussed infra.

System architecture 300 can include an Availability Zone 302. Availability Zone 302 Authentication and Account Layer can be a cloud infrastructure concept showing where the platform is hosted. The platform is deployed across availability zones to ensure high reliability and continuous service availability. This multi-zone approach provides redundancy and fault tolerance for the Self-Service SaaS Enablement Platform's critical services.

By way of example, three main service layers with their respective managers are now discussed. Orchestration Layer 304 can handle form services and orchestrates the self-service workflows. This layer acts as the liaison between a customer's SaaS product's prospective users and the SaaS product itself. It processes signup and login requests from the customer's marketing website and contains a self-contained compute and data layer that helps the platform scale, deploy rapidly, and maintain low latency.

Authentication and Account Layer 306 manages authentication and account-related processes. This layer receives authentication request payloads, verifies them with the customer's SaaS application, and processes acknowledgments. It also handles app roles, pricing plan selection, and tenant management which are essential in the self-serve journey to complete user sign-ups smoothly.

Analytics Layer 308 processes data for analytics and reporting. This is implemented as a Self-Hosted Clickhouse (by way of example) Analytics platform which processes and stores data regarding self-serve and PLG analytics related reports. It generates comprehensive reports across acquisition, activation, retention, engagement, and expansion metrics while maintaining core CRM objects including Users, Companies, and Teams.

Load Balancer and API Gateway Layer 310 manages incoming traffic and API requests. This component ensures optimal distribution of workloads and provides a unified entry point for all external communications with the platform. The API Gateway handles request routing, composition, and protocol translation to enable seamless integration with the SaaS builder's applications.

Data Storage Components 312 shows various databases for storing different types of data. The platform leverages multiple specialized data stores: S3 Bucket for storing raw objects, PostgreSQL database for relational data, and MongoDB for fast-changing NoSQL data. This multi-database approach optimizes storage and retrieval based on data characteristics and access patterns.

Analytics Dashboard 314 provides a user interface where analytics reports are displayed. This component visualizes the processed analytics data in meaningful charts, graphs, and metrics to help SaaS builders understand user journeys and make data-driven decisions for their product-led growth strategies.

CDN (Content Delivery Network) 316 can be used for performance optimization. This distributes the platform's static content and resources across geographically dispersed servers to reduce latency and improve access speed for end-users worldwide.

Logging and Monitoring 318 can be present across all layers for system monitoring and maintenance. This cross-cutting concern captures operational data from all platform components to enable real-time monitoring, troubleshooting, and performance optimization. The comprehensive logging system is essential for maintaining system health and identifying potential issues before they impact service quality.

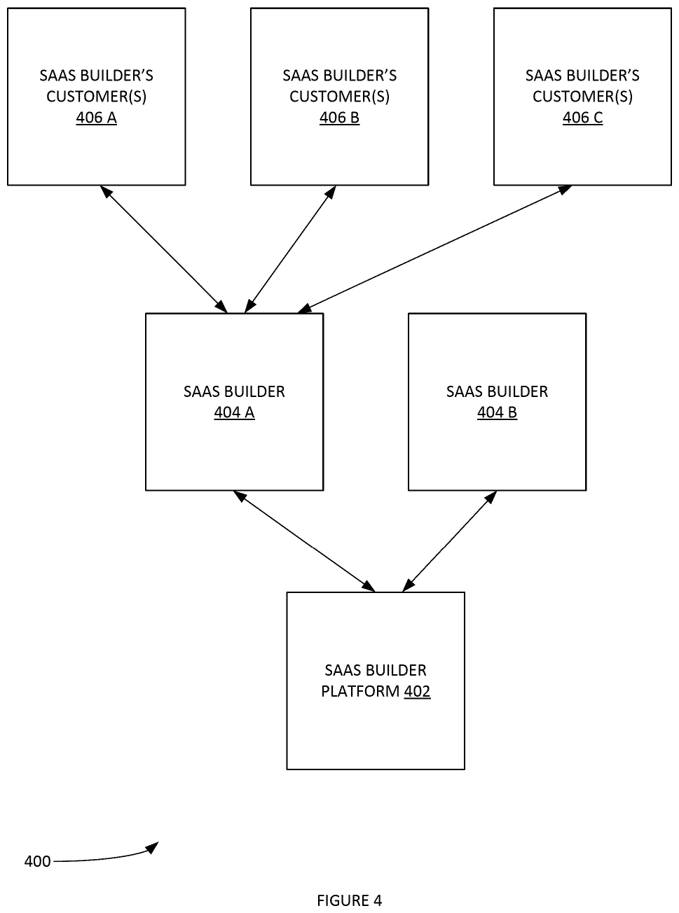

FIG. 4 illustrates an example SaaS builder system 400, according to some embodiments. SaaS builder system 400 includes SaaS builder platform 402 (e.g. a ThriveStack platform, etc.).

SaaS builder platform 402 is multi-tenant platform hosted on cloud-computing platform. SaaS builder platform 402 helps SaaS Builders 404 A-B to host and manage their self-serve orchestration and related analytics. SaaS builder platform 402 can build, analyze and drive a product-led growth strategy in a single solution. SaaS builder platform 402 is an integrated growth and monetization platform (e.g. see system 100 and process 200 supra). SaaS builder platform 402 is a comprehensive platform that enables self-service for bottom-up growth. This includes self-serve orchestration, products analytics and GTM playbooks. SaaS builder platform 402 seamlessly integrates with marketing channels and SaaS product(s) to manage and orchestrate each step of a signup and login process. SaaS builder platform 402 can enable users to build self-serve and start PLG journey for various products. SaaS builder platform 402 can include a sign-up page builder. SaaS builder platform 402 can enable users to manage self-service workflows. This can enable users to collaborate with engineering peers (e.g. create, edit, publish and monitor workflows that orchestrate software development processes, etc.) can include workflow debuggers for enabling engineering teams to test and validate their workflows across environments. SDKs and APIs for engineering teams. Additional information for implementing SaaS builder platform 402 is found in Appendix A, according to some embodiments.

SaaS Builder(s) 404 A-B can be a customer of SaaS builder platform 402. SaaS Builder(s) 404 A-B are builders of SaaS services. SaaS Builder's SaaS product is the SaaS Builder's SaaS product to which customers want to integrate with SaaS builder platform 402 and generate metrics/analytics.

SaaS Builder's Customer(s) 406 A-C can be an organization and its employees who are exploring a SB's product for their use cases. SaaS Builder(s) 404 A-B may wish to understand their accounts' usage of the product.

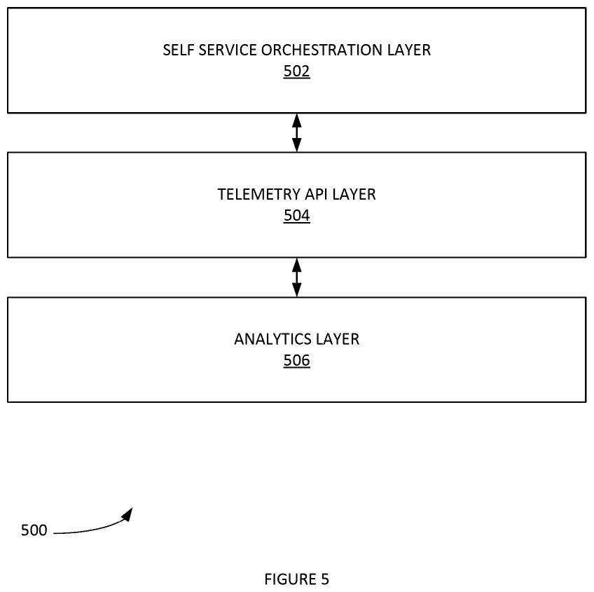

FIG. 5 illustrates an example platform interaction process 500 with a customer's SaaS product, according to some embodiments. Process 500 includes the implementation of a Self-Service Orchestration Layer 502.

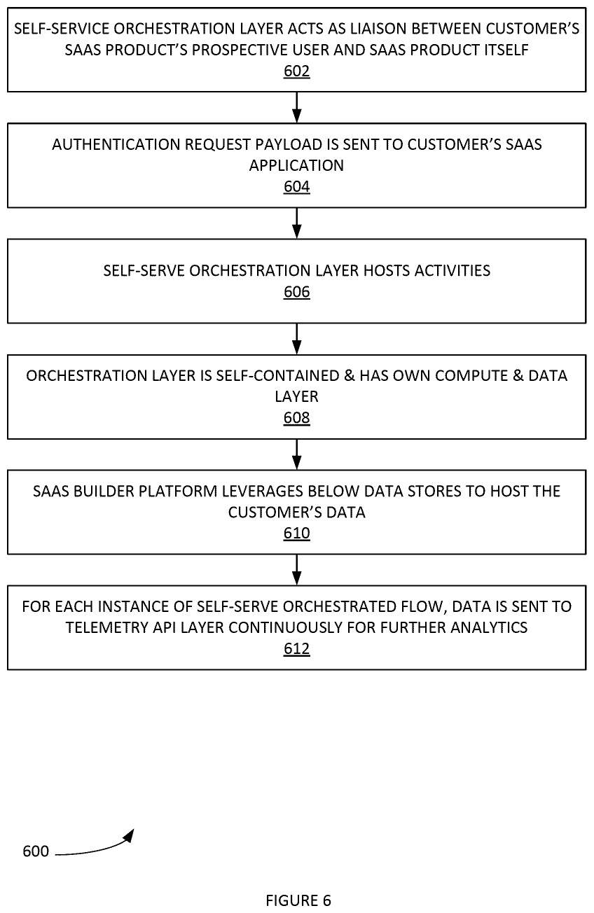

FIG. 6 illustrates an example process 600 for implementing a Self-Service orchestration layer, according to some embodiments. In step 602, Self-Service orchestration layer 502 acts as liaison between Customer's SaaS product's prospective user and SaaS product itself. Any request sent by prospective user of SaaS product, for example: signup and login requests from Customer's marketing website are sent to SaaS builder platform 402 which hosts the signup/login pages.

In step 604, authentication request payload is sent to customer's SaaS application, where it is verified and sent back to SaaS builder platform 402 as an acknowledgement.

In step 606, Self-Serve Orchestration layer hosts activities like application roles, pricing plan and tenant management, which are important in self-serve journey to complete the user sign-ups smoothly.

In step 608, Orchestration layer is self-contained and has its own compute and data layer which helps the platform to scale, deploy fast and maintain low latency.

In step 610, SaaS builder platform 402 (e.g. a multi-tenant platform, etc.) leverages below data stores to host the customer's data.

By way of example, here an S3 Bucket stores the raw objects. A Postgres DB stores the relational data. A Mongo DB stores fast changing NoSQL data.

In step 612, for each instance of self-serve orchestrated flow, data is sent to telemetry API layer continuously for further analytics.

In step 504, process 500 implements a Telemetry API Layer. This layer acts as bridge between self-serve orchestration layer and an analytics layer. Customers obtain their PLG analytics data in two ways.

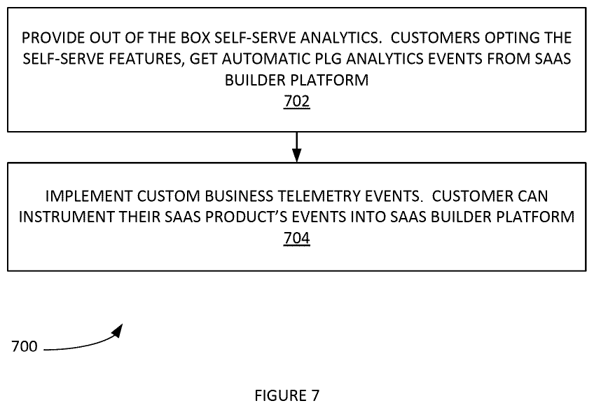

FIG. 7 illustrates an example process 700 for implementing a Telemetry API Layer, according to some embodiments. In step 702, process 700 provides out of the box self-serve analytics. Customers opting the Self-Serve features, get automatic PLG analytics events from SaaS builder platform 402.

In step 704, process 700 implements custom business telemetry events. Customer can instrument their SaaS Product's events into SaaS builder platform 402 which internally uses telemetry APIs to capture the data. SaaS builder platform 402 provides the public telemetry APIs to customers using which they can seamlessly integrate their product event with analytics. In this option, customers can send the telemetry events explicitly via SDKs.

In step 506, process 500 implements an Analytics Layer.

SaaS builder platform 402 analytics layer includes a self-hosted click-house analytics platform which processes and saves data regarding self-serve and PLG analytics related reports. These reports can be generated from the data of either self-serve orchestration layers or Telemetry events sent by customer's product.

Analytics can contain the following types of data, inter alia:
Reports (e.g. Acquisition, Activation, Retention, Engagement, Expansion, etc.); and
CRM objects (e.g. User, Companies, Teams, etc.).

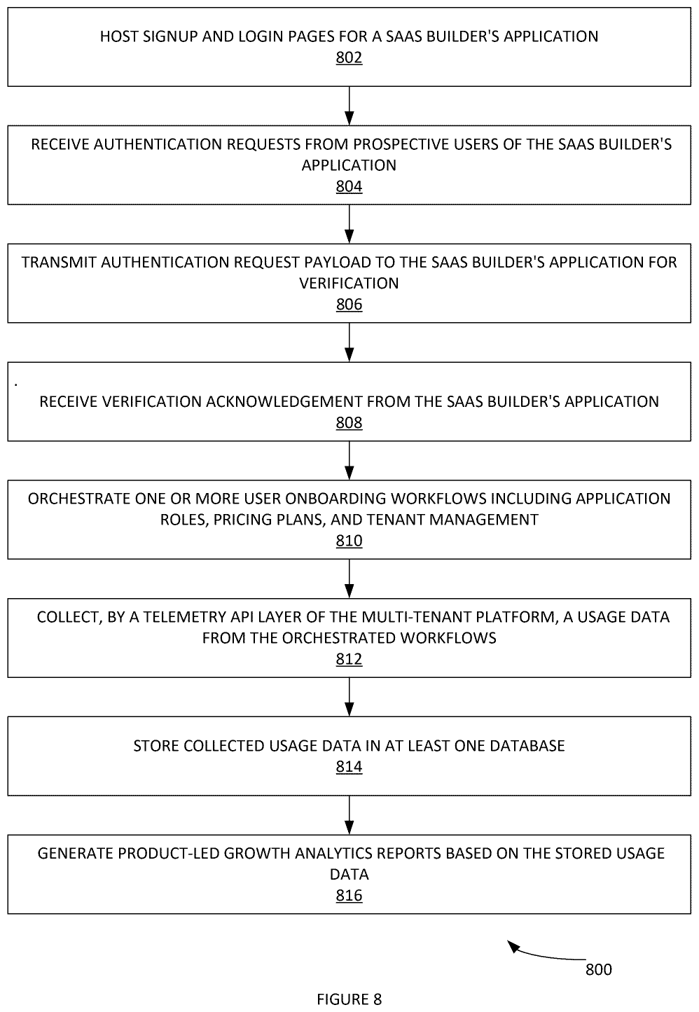

FIG. 8 illustrates an example process 800 for enabling self-service capabilities in Software as a Service (Saas) applications, according to some embodiments. In step 802, process 800 hosts, by a multi-tenant platform, signup and login pages for a SaaS builder's application. In step 804, process 800 receives, by the multi-tenant platform, authentication requests from prospective users of the SaaS builder's application. In step 806, process 800 transmits, by the multi-tenant platform, the authentication request payload to the Saas builder's application for verification.

In step 808, process 800 receives, by the multi-tenant platform, a verification acknowledgement from the SaaS builder's application. In step 810, process 800 orchestrates, by a self-service orchestration layer of the multi-tenant platform, one or more user onboarding workflows including application roles, pricing plans, and tenant management. In step 812, process 800 collects, by a telemetry API layer of the multi-tenant platform, a usage data from the orchestrated workflows. In step 814, process 800 stores the collected usage data in at least one database. In step 816, process 800 generates, by an analytics layer of the multi-tenant platform, product-led growth analytics reports based on the stored usage data.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A method for enabling self-service capabilities in Software as a Service (Saas) applications, comprising: hosting, by a multi-tenant platform, signup and login pages for a SaaS builder's application; receiving, by the multi-tenant platform, authentication requests from prospective users of the SaaS builder's application; transmitting, by the multi-tenant platform, authentication request payload to the SaaS builder's application for verification; receiving, by the multi-tenant platform, verification acknowledgement from the SaaS builder's application; orchestrating, by a self-service orchestration layer of the multi-tenant platform, user onboarding workflows including application roles, pricing plans, and tenant management; collecting, by a telemetry API layer of the multi-tenant platform, usage data from the orchestrated workflows; storing the collected usage data in at least one database; and generating, by an analytics layer of the multi-tenant platform, product-led growth analytics reports based on the stored usage data.

2. The method of claim 1, wherein the multi-tenant platform includes a no-code methodology for configuring the signup and login pages.

3. The method of claim 1, wherein collecting usage data comprises receiving telemetry events through at least one public API.

4. The method of claim 1, wherein the at least one database comprises a relational database, a NoSQL database, and an object storage system.

5. The method of claim 1, further comprising providing software development kits (SDKs) to the SaaS builder for integration with the SaaS builder's application.

6. The method of claim 1, wherein the analytics layer generates reports comprising at least one of: acquisition metrics, activation metrics, retention metrics, engagement metrics, and expansion metrics.

7. The method of claim 1, further comprising providing a workflow debugger for testing and validating the orchestrated workflows across multiple environments.

8. The method of claim 1, wherein the self-service orchestration layer comprises a self-contained compute and data layer to enable scaling, fast deployment, and low latency.

9. The method of claim 1, further comprising receiving custom business telemetry events from the SaaS builder's application for inclusion in the analytics reports.

10. The method of claim 1, wherein generating analytics reports comprises processing data using a self-hosted click-house analytics platform.

11. The method of claim 1, further comprising enabling Go-to-Market teams to implement and experiment with self-service monetization strategies through the platform.

12. The method of claim 1, further comprising managing user identification, authentication, registration, data-enrichment, and email notifications.

13. The method of claim 2, wherein the no-code methodology enables transformation of conventional contact forms into signup and login experiences.

14. The method of claim 6, wherein the analytics reports facilitate cross-functional collaboration between teams of the SaaS builder.

15. The method of claim 9, wherein the custom business telemetry events are received through SDKs provided to the SaaS builder.
